(19) United States
(12) Patent Application Publication
(10) Pub. No.: US 2009/0225788 A1
(43) Pub. Date: Sep. 10, 2009

(54) Synchronization of media display with recording of audio over a telephone network

(75) Inventors: Janet H. Kephart, Denver, CO (US); Leigh Steere, Superior, CO (US); Jafar Nabkel, Longmont, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: TANDEM READERS, LLC, Denver, CO (US)

(21) Appl. No.: 12/109,250

(22) Filed: Apr. 24, 2008

Related U.S. Application Data
(63) Continuation-in-part of application No. 12/044,627, filed on Mar. 7, 2008.
Application No. 12/044,627 is a continuation-in-part of application No. 12/057,136, filed on Mar. 27, 2008.

(51) Int. Cl. H04J 3/06

(52) U.S. Cl. 370/503

(57) ABSTRACT

A sender is presented with a media selection that is delivered in discreet segments from a media server over a distributed network to a client computer or other presentation device. The sender can annotate each media segment and record, also in segments, a reading of any text of the media and any additional commentary, including observations or opinions regarding musical or video media streams. The voice data, i.e., the “audio performance,” is transmitted from a sender telephone connected to a telephone network to a voice server associated with the media server. The segments of audio are synchronized with the media segments and assembled with prerecorded segment cues. In one implementation, a user, for example, a grandparent, can view the pages of a children's book through an Internet web browser, add or edit personal anecdotes, and read the book for page-by-page recording over the telephone network to a storage server for later presentation to a grandchild.

### CROSS REFERENCE TO RELATED APPLICATIONS

This application is a continuation-in-part of U.S. patent application Ser. No. 12/044,627 filed 7 Mar. 2008 entitled “Synchronized display of media and recording of audio over a network,” which is hereby incorporated herein by reference in its entirety. This application is also a continuation-in-part of U.S. patent application Ser. No. 12/057,136 filed 27 Mar. 2008 entitled “Fulfillment of an audio performance recorded across a network based on a media selection,” which is hereby incorporated herein by reference in its entirety.

### BACKGROUND

In modern society, extended families are often separated by great geographic distances due to circumstances of employment locations, retirement decisions, or merely personal preference for location and lifestyle. It may further be difficult for families to physically visit each other regularly due to the significant distance, cost of travel, or health conditions limiting or preventing travel. Modern technologies have helped bridge this divide by increasing the ease of communications between separated family members. The telephone network is the most obvious example. Additionally, computer networks such as the Internet have made it even easier for family members to quickly communicate with each other in many ways and formats. In addition to electronic mail messages and instant messaging, family members can exchange digital photographs and video as well as post such images to a family web site to allow access, viewing, and message posting by any family member. Further, third party service providers, e.g., photographic developers, have created Internet platforms for the presentation and viewing of electronic photo albums that allow families to share visual experiences and perhaps annotate the pictures with text comments. It is in the spirit of this background that the technology disclosed herein was developed as an alternative way for families to share and interact.

The information included in this Background section of the specification, including any references cited herein and any description or discussion thereof, is included for technical reference purposes only and is not to be regarded subject matter by which the scope of the invention is to be bound.

### SUMMARY

The disclosed technology enables a person, using a networked presentation device, for example, an Internet web browser on a computer, to view a presentation or stream of media presented in segments. The media, for example, images and/or text (e.g., pages of a book), music, or video, stored at or accessible by a media server may be delivered in discreet segments over a distributed network to a client computer or other presentation device. The person can annotate each media segment and record, in segments as well, e.g., a reading of the text of a book, and any additional commentary including, for example, observations or opinions regarding sound or video media streams, using the network presentation device and a telephone. The voice data, i.e., the “audio performance,” may be transferred over the telephone network to the server computer. The segments of audio may be synchronized with the media segments and assembled with prerecorded segment cues (e.g., “turn the page now”). In one implementation, the audio performance may be synchronized and assembled with a stream of the corresponding media.

In one exemplary implementation, the technology may be used to allow a person, for example, a grandparent, to view the pages of a children's book through an Internet web browser, to add or edit personal anecdotes, and to read the book for page-by-page recording over a telephone network to a storage server for later presentation to a grandchild. Once recorded, the media server may write the audio recording to a physical medium, for example, a compact disk (CD), digital versatile disk (DVD), removable flash memory storage device, analog or digital audio tape, analog or digital video tape, floppy disk or other portable or removable storage medium. The physical medium may then be packaged with a printed copy of the book and sent to the grandchild. In an alternate embodiment, the grandchild may be provided a web link to download the audio recording, for example, as an MP3 file for presentation on an MP3 compatible device, and listen to the recording while viewing a printed copy of the book. In a further embodiment, the audio recording may be combined with a visual presentation of the pages of the book and stored on a CD or DVD that is packaged and shipped to the grandchild for presentation on a computer or DVD player. In yet another embodiment, the grandchild may simultaneously listen to the recorded audio while viewing an electronic copy of the book via a web browser. In another embodiment, the grandchild may listen to the recorded audio through a telephone while viewing a physical or electronic copy of the book.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of an exemplary system for implementing the synchronized display of media and recording of audio over a combination of networks.

FIG. 2 is a schematic diagram of an exemplary browser interface for allowing a sender to view, annotate, and record an audio performance related to a media selection.

FIG. 3 is a flow diagram of exemplary operations for recording an audio performance and synchronizing the audio performance associated with a media selection across a combination of network.

FIG. 4 is a flow diagram of exemplary operations for recording an audio performance associated with a media selection over a telephone network.

FIG. 5 is a flow diagram of operations for one exemplary implementation of fulfillment of a media and audio performance package for a recipient.

FIG. 6 is a flow diagram of operations for an alternative exemplary implementation of fulfillment of a media and audio performance package for a recipient.

FIG. 7 is a schematic diagram of an exemplary computer system for implementing operations for synchronizing the display of media and recording of audio over a network.

### DETAILED DESCRIPTION OF THE INVENTION

The synchronized display of multimedia and recording of audio may be realized across a communications network linking several pieces of computer hardware controlled by a combination of standard and special purpose software operating in conjunction to form a distributed system. The system may primarily include a client device at a sender location, for example, a personal computer, connected via a network to a media server computer that further manages one or more databases. The system may further include a telephone at the sender location connected via a telephone network to a voice server computer that further manages tone and voice input and sound recording. The person who creates an audio recording using the system is referred to herein as the “sender.” Similarly, the person who receives the audio recording, often in conjunction with a book or other media, is referred to herein as the “recipient.” In a common implementation, a sender may use an Internet web browser operating on the client device to access a web site hosted by the server computer over a network.

In one exemplary implementation, the server computer may present a typical web store offering a variety of children's books. The sender is presented with an interface through which she is able to browse the available books, select one or more books, and then proceed to check out. Alternatively, purchase and checkout functions may be performed after the recording process is completed as further described below. The server computer may host a typical electronic commerce purchasing system that may be integrated or used in conjunction with the synchronized media presentation and recording software described herein.

Once a book is selected or purchased, the server computer may then present each page of the purchased book to the sender through the web browser interface. Controls may be provided in the web browser interface for control and navigation of the book. The web browser may present images of each page in the book, including text and illustrations, to allow the sender to record a performance of the book. For example, the “text and illustrations” may be a combination of text characters and a scalable illustration or fixed bitmap of an illustration, or a low-resolution bitmap of each page (including text as pixels in the bitmap), which is sufficient for display but not for high quality printing. Through the browser interface, the sender may have options to view each page of the book and to enter comments or notes in an annotation edit area associated with each page. These annotations may be a list of personal anecdotes, comments about the story, or a complete scripted dialogue the sender wants to record for a future playback by the recipient. The annotations are stored by the server computer on a network database associated with both the book and the sender for future use by the sender when recording a performance of the book.

Once a sender has reviewed the book, added any desired annotations, and is ready to record, the server computer will present the first page of the book in the browser interface. The sender may then use a telephone to communicate with a voice server over a telephone network and record audio segments through the telephone corresponding to pages of the book viewed in electronic form on the sender's computer. The voice server may be equipped with a telephone input system (e.g., an interactive voice response (IVR) system and/or a “touch-tone” dual-tone multi-frequency (DTMF) system) that enables the sender to select the book and record audio segments corresponding to pages of the book. The telephone input system may verbally prompt the sender to indicate the page being read, to read the current page, and to include the sender's notes and anecdotes in the recording. The voice server may mark each audio segment recorded by the sender corresponding to each page of the book and send each marked audio segment to the media server, where the audio segment is associated with the corresponding book segment. The telephone input system may also provide the sender with options to review the current recording for the page, to add an additional recorded segment (either through insertion or appendage), to cancel the recorded segment, record over with a new segment, to accept a recorded segment, and to save the current session to return later for further recording.

Alternatively, once a sender has reviewed the book, added any desired annotations, and is ready to record, the media server may present the first page of the book in the browser interface. Instructions within the browser interface may prompt the sender to read the current page and include the sender's notes and anecdotes in the recording while the sender records an audio segment via a telephone onto the voice server. The voice server marks each audio segment recorded by the sender corresponding to each page of the book and sends each marked audio segment to the media server, where the audio segment is associated with the corresponding book segment. Once the sender has completed recording a page, the browser interface may be updated to provide the sender with options to review the current recording for the page, to add an additional recorded segment (either through insertion or appendage), to cancel the recorded segment, record over with a new segment, to accept a recorded segment, and to save the current session to return later for further recording.

Once the sender has completed recording segments for each page of the book, the server computer synchronizes each recorded segment from the saved audio recordings of the sender's performance with the corresponding display segments, e.g., pages from the books. In one embodiment, the server computer may assemble the recorded performance and the media into an integrated multimedia format. Completed media and audio performance combinations may be made available in several different forms. For example, the completed audio performance may be transferred to a physical medium, e.g., an audio CD, flash media, a floppy disk, or an audio tape, and a manufacturing or fulfillment center may then ship physical medium storing the recorded performance together with a tangible copy of the media, e.g., a book, as a packaged product to the recipient. In another embodiment, the recorded audio performance may be combined with the media on a multimedia CD, DVD, or video tape for physical fulfillment, or alternatively may be transmitted to a recipient as a multimedia streaming internet presentation, a telephone network accessible audio file, and other combinations.

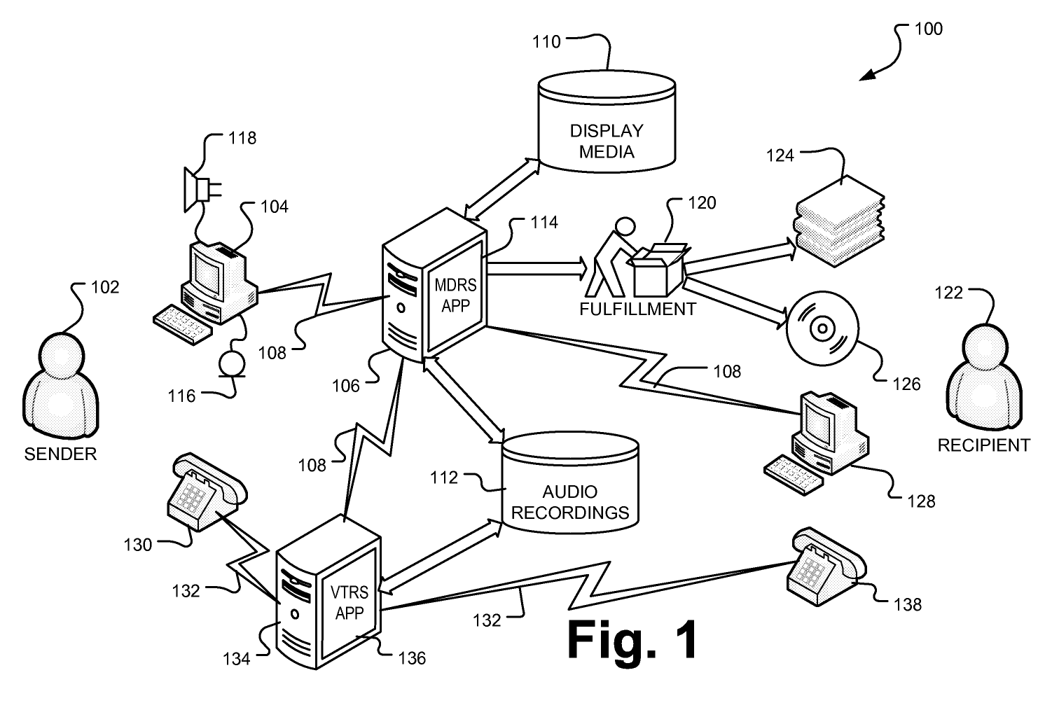

FIG. 1 depicts one exemplary implementation of a system 100 for synchronizing the display of multimedia and the recording of related audio across a network. The sender 102 may use a personal computer 104, a telephone 130, or other computing or communication device to communicate with a media server 106 and/or a voice server 134 over a wired or wireless networks 108 and 132, or both. The media server 106 generally connects with the network 108 via a network link. The voice server 134 generally connects with a telephone network 132 (e.g., a public switched telephone network (PSTN)) and communication network 108 via network links. The personal computer 104 may be a desktop computer, a laptop or notebook computer, a personal digital assistant, a smart phone, or any other computing or communication device that is capable of providing appropriate interface and connectivity functionality to communicate with the media server 106 over the network 108. In many instances, the network 108 will likely be the Internet; however, other forms of public and private communications networks may likewise be used.

The sender's telephone 130 may be any wired or wireless telephony device capable of providing appropriate interface and connectivity functionality to communicate with the voice server 134 over the telephone network 132. The telephone network 132 may be a standard PSTN, a wireless network, a cable network, a microwave network, a satellite network, a voice-over-internet-protocol (VOIP) network, or other telecommunications network, or any combination thereof.

A media display, recording, and synchronization (MDRS) application 114 may execute on the media server 106 to provide the primary functionality of the system 100. The media server 106 may further maintain or have access to one or more media repositories. A presentation media data repository 110, e.g., a database, may store all available media files for use by the system 100. Such media files may include electronic copies of books, music, video, and other similar forms of media. Such media files may be categorized within the display media data repository 110 by one or more criteria, for example, by title, author, subject, target audience age, cost, and other similar criteria. The media server 106 may also be connected with an audio recording data repository 112 which stores audio recordings or “performances” made by multiple senders. The audio recording data repository 112 may index the audio recordings by sender name, sender identification media title, author, date of recording, and other similar criteria. The MDRS application 114 on the media server 106 provides an interface for indexing and control of reads and writes from and to the media data repository 110 and the audio recording data repository 112.

The MDRS application 114 may be designed to function as, or to interface with, the standard web service application to allow for simple access by a sender 102. Note, however, that this aspect of the system 100 may be implemented in a variety of different ways including, for example, in a direct client server application format. In an exemplary implementation, a sender may use an Internet browser application on her personal computer 104 to access a web site hosted on the media server 106 over the network 108. The web site may be a component of the MDRS application 114 or it may operate as an intermediate interface to the MDRS application 114.

The system 100 may also include a voice touchtone recording and synchronization (VTRS) application 136 that executes on the voice server 134 to provide additional functionality of the system 100. The voice server 134 may further maintain or have access to one or more media repositories, such as the audio recording data repository 112. The VTRS application 136 on the voice server 134 provides an interface for indexing and control of reads and writes from and to the audio recording data repository 112.

The MDRS application 114 and the VTRS application 136 may be housed on separate servers such as the media server 106 and the voice server 134 as shown in FIG. 1. The separate servers may be connected via a network 108 such as a local area network (LAN), wide area network (WAN), or the internet. Accordingly, the separate servers may be located at any physical distance from one another. Alternatively, the MDRS 114 and VTRS 136 applications may be housed on one computer server that functions as both a media server 106 and a voice server 134 as described herein.

The web site on the media server 106 may present a typical web store interfaced to the sender 102 offering a variety of media files, for example, a selection of children's books. The sender will be able to search or browse the books or other media available through the web store, select one or more media titles for purchase, and then proceed to check out. At this point a typical electronic commerce processing platform may be used to complete the purchase of the media. This electronic commerce platform may be fully integrated in the MDRS application 114 or alternatively may be an adjunct software program utilized to complete a purchase transaction. Note that the actual “purchase” of the book might be done before or after recording the performance. In another implementation, for example, the sender may “select” a book, proceed and complete their recording, and then, before submitting their book for delivery, actually complete the ordering and payment process. This would allow a sender to be satisfied with the recorded results before paying, and then possibly to send the recorded book to multiple recipients.

Once the selection or purchase of the media item is completed, the MDRS application 114 may present a new interface to the sender 102 to be used in conjunction with the VTRS application 136 for creating audio recording of or associated with the media selection. As described in greater detail herein, the MDRS application 114 may provide one or more interfaces within the browser application on the sender's computer 104 to present the sender options to view the selected media in segments (e.g., each page of the book) and enter textual comments or annotations. The telephone input system implemented by the VTRS application 136 may allow a user to enter audio comments or annotations to be associated with particular segments of the media selection viewed within the web browser interface. The VTRS application 136 may synchronize the audio comments or annotations recorded through the sender's telephone 130 with the MDRS application 114 though the network 108. The MDRS application 114 or VTRS application 136 may store the sender's annotations in a network database that is associated with both the sender, e.g., through a unique identification number, and with the media selection itself.

After the sender 102 has reviewed the media selection and has added any desired annotations, the MDRS application 114 may enter into a recording mode. The sender 102 may communicate with the voice server 134 via the telephone 130 and progress through the media segment-by-segment (e.g., page-by-page in a book) as presented by the MDRS application 114, reading the text and providing commentary for each segment that is recorded by the VTRS application 136. The system 100 may support multiple modes of recording. In a first implementation, recording is conducted by the VTRS application 136 on the voice server 134 through a telephone input system for recording an audio performance of the media selection at the sender's telephone 130 over the telephone network 132. Additional modes of recording may be achieved by installing a specific client software module on the sender's computer 104, by using various voice over internet protocols (VOIP), or by using other web browser based recording software (e.g., ActiveX, Java, Ajax, Flex, or other browser-based technologies). In this implementation, the sender's computer 104 may be equipped with a microphone 116 and one or more loudspeakers 118, either of which may be built-in or external to the sender's computer 104.

The sender 102 may desire to effectuate a recording of the media selection using the telephone 130 rather than a microphone 116 associated with the sender's computer 104 because, for example, the sender's computer 104 may not be equipped with a microphone 116, or the microphone 116 may not be configured properly for recording with web-based software, or the sender simply may not feel comfortable using the microphone 116 to record. The sender 102 may progress through the media segment-by-segment (e.g., page-by-page in a book) and read the text and provide commentary for each segment via the telephone 130 that is recorded by the VTRS application 136.

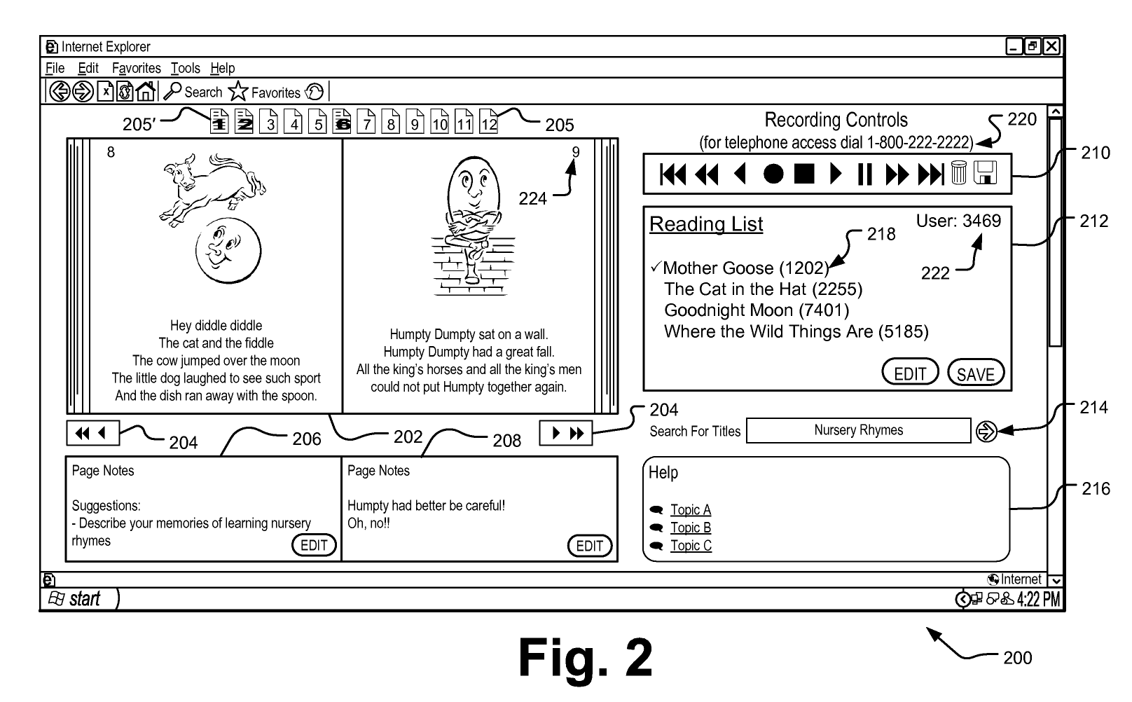

The MDRS application 114 may next provide tools within the browser interface for allowing the sender 102 to effectuate a recording of the media selection. The MDRS application 114 may begin a recording session by presenting the first media segment of the media selection (e.g., the first page of the book) along with instructions to the sender 102 to call a specific telephone number associated with the voice server 134 with her telephone 130 and to follow additional instructions given over the telephone 130 by the VTRS application 136 including reading the current media segment as well as providing any additional comments or anecdotes as desired. In addition to displaying the media segment, the MDRS application 114 may further present any annotations previously entered by the sender 102 in order to aid the sender 102 during the recording process as further described in greater detail below with respect to FIG. 2.

In one embodiment, the VTRS application 136 may provide tools within a touchtone or voice automated interface for allowing the sender 102 to effectuate a recording of the media selection. After the sender calls a specific telephone number associated with the voice server 134 using the telephone 130 as instructed by the MDRS application 114, the VTRS application 136 may verbally request the sender's identity as well as the sender's media selection. The sender 102 may respond verbally and/or via touchtone selections depending on the type of telephone input system associated with the VTRS application 136. Alternately, the sender might even respond to the prompts heard over the telephone 130, by selecting the appropriate option on the browser interface as further described below with respect to FIG. 2.

The VTRS application 136 may then begin a recording session by audibly instructing the sender 102 to first press a numerical button on the telephone 130 or say an audible command to begin recording, or select a button or option in the browser interface, next read the current media segment as well as provide any additional comments or anecdotes as desired, and then press another numerical button on the telephone 130 or audible command to end recording. The VTRS application 136 may also be configured to begin and/or end recording after a predetermined period of silence. The sender 102 may then progress to the next media segment of the media selection on the MDRS application 114 via the browser interface and begin another recording session on the VTRS application 136 as described above. When the sender 102 is finished recording media segments of the media selection, the telephone call may be terminated by the sender 102. Alternately, the call may continue for the VTRS application 136 and MDRS application 114 to playback the audio recording for review by the Sender.

In an alternate implementation, audio data may simply be input at the sender's computer 104 via the microphone 116 and directly transmitted to the server computer 106, for example, using voice over internet protocols (VOIP). In another implementation, the audio data input by the sender may be streamed (e.g., using Flash or Real Audio software) from the sender's computer 104 to the server computer 106. In yet another implementation, audio data may be collected, for example, by installing a specific client software audio recording module on the sender's computer 104 or by using other web browser based recording software (e.g., ActiveX, Java, Ajax, Flex, or other browser-based technologies).

Once a recording for a particular media segment is completed, the VTRS application 136 may mark each audio segment recorded by the sender 102 by associating the audio segment with a unique identifier of the sender 102 and further associating the recorded segment with the corresponding media segment. Recording of the media selection will continue in this fashion on a segment-by-segment basis until the entire media selection has been recorded. The sender 102 may be provided with options to review the current recording for each segment before progressing to the next segment by listening to the recording via the telephone 130 or via the computer speaker 118, to cancel the recorded segment and record a new segment, to edit a recorded segment by inserting additional comments or appending additional comments to the end of the segment, and to accept a recorded segment in order to proceed to the next segment. In addition, the VTRS application 136 may allow the sender 102 to suspend and store the current recording session to return at a later time to complete the recording of the media selection.

Once a sender has completed a recording of all segments for a particular media selection, the segments of the audio performance are synchronized or mapped to the corresponding segments of the media selection. Alternatively, each audio segment may be synchronized with corresponding segments of the media selection individually as the sender records. Further, each audio segment recorded via the VTRS application 136 may be accessed by the sender via the MDRS application 114 for reviewing, editing or other purposes.

The sender may operate the VTRS application 136 in conjunction with the MDRS application 114 when recording an audio segment as discussed above and may operate and control the VTRS application 136 using the MDRS application 114 through the browser interface when recording an audio segment. The sender 102 may view the media selection on the sender's computer 104 while using the VTRS application 136 via the sender's telephone 130 to record one or more audio segments associated with the media selection.

Because the sender may record in segments and may further rerecord some of those segments, there is a likelihood that the finished recorded performance will have different audio volumes between the sections. This variance in recording levels between recorded segments may be caused, for example, by differing positions of the telephone's microphone, differing distances of the sender to the telephone, use of a speakerphone, or other disparities in the recording input. To address any inconsistencies in recording levels between segments, the MDRS application 114 or the VTRS application 136 may incorporate editing software to ensure even sound quality and volume throughout. Such audio editing functions may be automated so that all recording segments are edited against pre-established criteria for normalization before compiling a complete recorded performance.

The MDRS application 114 or the VTRS application 136 may further automatically annotate each recorded segment for ease of use by the recipient. For example, the MDRS application 114 or the VTRS application 136 may insert pauses between recorded segments to allow a recipient 122 to move to the next media segment, e.g., turn the page of a book. Additionally, audio cues, for example, audible directions to turn to the next page, may also be inserted between the recorded audio segments. The completed recording of a media selection may then be stored in the audio recording data repository 112 for later and potentially perpetual access in a one time or on-demand fulfillment process. Alternately, the sender may be given the option to record one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

In one exemplary implementation, a fulfillment process 120 may be at least partially manually implemented. Once a sender's recording has been completed, the MDRS application 114 may generate fulfillment instructions identifying a recipient 122 and a corresponding shipping address provided by the sender 102 and associate this recipient information with an identification of the sender's media selection and/or a related audio recording made by the sender 102. The audio recording may be automatically copied to a physical media, for example, a CD, flash storage device, or DVD, by the MDRS application 114, or such a copy of the sender's recording may be initiated manually as part of the fulfillment process 120. In this implementation, a copy of the media selection, e.g., a book, and a copy of the corresponding audio recording 126, e.g., a CD or DVD, may be packaged together for shipment to the recipient 122. Upon receipt of the shipment, the recipient 122 may play the audio media 126 while simultaneously following along with a copy of the physical media 124 (e.g., a book).

In an alternate fulfillment embodiment, the recipient 122 may be notified of the availability of a media selection and corresponding audio recording prepared by the sender 102 for the recipient's benefit. Such a notification may come in the form of an electronic mail message sent by the MDRS application 114 from the media server 106 to a computing device 128 associated with the recipient 122. Alternately, the MDRS application 114 may send an electronic message to another mail distribution server which, in turn, sends it to the computing device 128 associated with the recipient 122. In yet another embodiment, notification may be sent physically through the postal service or other delivery service to the recipient's shipping address. The recipient's computing device 128 may be connected with the media server 106 via the network 108, for example, the Internet (whether wired or wireless), or via a similar network. In one embodiment of this implementation, the media selection and accompanying audio recording of the sender 102 may be sequentially served or streamed to the recipient's computing device 128 for presentation in a browser interface. Alternatively, the recipient may download a complete copy of the media selection and the associated audio recording from the sender 102 for local presentation on the recipient's computing device 128.

In a hybrid implementation, the media selection 124 may be manually fulfilled, e.g., by shipping a copy of the book to the recipient 122, while the audio recording of the sender 102 may be fulfilled electronically, e.g., by the recipient 122 downloading a copy of the audio file from the media server 106 to the recipient's computing device 128. The audio file may be in any known form, for example, MP3, WMV, MPEG, or other digital format, and may be played back on the recipient's computing device 128 or transferred to another playback device, e.g., an MP3 player. In yet another implementation, the audio recording of the sender 102 may be fulfilled via the telephone network 132, e.g., by the recipient 122 using a telephone 138 to access the audio file from the voice server 134. In this implementation, the media selection 124 may be manually fulfilled as well, e.g., by shipping a copy of the book to the recipient 122 or electronically fulfilled using any of the aforementioned methods.

An exemplary browser interface 200 for facilitating the synchronization of the media display and audio recording is presented in FIG. 2. The sender's media selection 202, in this example in the form of a children's book, is presented in the browser window 200. It may be desirable to present the media selection 202 within the browser window 200 in the same or almost identical format as the media selection that will ultimately be received by the recipient. For example, if the recipient will receive a printed copy of a book, the media selection 202 displayed in the browser window 200 may depict text and images in the same manner and fashion as the text and images are printed in the book in order to allow the sender to record and comment on exactly what the recipient will see. This may be achieved by presenting a bitmap image or other digital image format of the pages of the book. For example, the text and images may be a combination of text characters and a scalable illustration or fixed bitmap of an illustration, or a low-resolution bitmap of each page (including text as pixels in the bitmap), which is sufficient for display but not for high quality printing.

The browser interface 200 may also provide the sender with media segment selection controls 204 as an interface feature. In the example of a book, the segment selection controls 204 may allow the sender to move forward or backward through the book page by page or alternately to skip to the beginning or the end of the book. In addition, or in an alternate embodiment, the browser interface 200 may also includes small page icons 205 which allow the sender to navigate easily through the pages of the book and visually see which pages have already been recorded, e.g. as a highlighted page icon 205′. In addition, the browser interface 200 may provide annotation windows 206, 208 associated with each media segment of the media selection 202 as another interface feature. The sender may use the annotation windows 206, 208 to enter notes, comments, and reminder cues of additional anecdotes the user would like to make while recording the text of the media selection (e.g., reading a story). Editing within the annotation windows 206, 208 may be controlled through the selection of an edit button to prevent accidental overwriting or deletion of previously inserted comments.

In the example depicted in FIG. 2, the first annotation window 206 associated with page 8 of the media selection 202 provides a suggested annotation to the sender in the event the sender has difficulty developing her own comments or anecdotes. In this example, the media selection 202 is a book of nursery rhymes and the suggested commentary directs the sender to “describe your memories of learning nursery rhymes.” The sender may enter any additional comments spurred by this suggestion in the first annotation window 206. As shown in the second annotation window 208, the sender has already inserted comments with respect to page 9 of the media selection 202 that she would like to make in conjunction with the Humpty Dumpty nursery rhyme, exclaiming that “Humpty had better be careful!” and “Oh, no!!” when the character falls off the wall.

The browser interface 200 may further provide the sender with a selection of recording controls 210 for use in recording the text of the media segment 202 and any accompanying comments and anecdotes. The recording controls 210 may include several functions, for example, skip to beginning, fast rewind, rewind, record, stop, play, pause, fast-forward, skip to end, erase, and save. While the browser interface shows a selection of manual recording controls 210, this is merely one exemplary implementation of a possible recording feature. In one embodiment, the sender may use either the recording controls 210, or DTMF or voice controls via the sender's telephone 130, or a combination of the two sets of controls, switching back and forth whenever the sender desires. In other implementations, the browser interface 200 could direct the recording process through the use of a “wizard” module that would lead the sender through a series of steps to assist the sender in recording, reviewing, and saving a sound recording of a performance of each media segment 202.

The browser interface 200 may provide additional functionality for a sender. For example, the browser interface 200 may provide a reading list window 212 through which the sender can view a list of media selections purchased for recording and sending to recipients. The reading list window 212 may provide an indication of which media selection is presently selected for recording an annotation; in this instance, Mother Goose is shown as selected. In some implementations, the media selection presented in the reading list window 212 may be perpetual thereby allowing a sender to send a media selection and associated sound recording to multiple recipients at various times, or to edit the sound recordings to prepare a number of customized recorded performances of a particular media selection for each of multiple recipients. In a further implementation, the MDRS application and/or VTRS application may allow a sender to create and store different versions of recordings for a particular media selection for fulfillment to different recipients.

The browser interface 200 may further provide the sender with a telephone number 220 to be used to access the voice server and record the text of the media segment 202 and any accompanying comments and anecdotes. The browser interface 200 may also provide the sender with a unique user identification 222 (e.g., a number or password) and media selection identifications 218 for each media selection. The user identification 222 may be input over the telephone to identify the sender to the voice server. Further, the media selection identification 218 may be input over the telephone to identify the media selection to the voice server. In one implementation, the media selection identification 218 may be a number associated with the media selection and presented to the sender in the reading list window 212 as shown in FIG. 2. The browser interface may further indicate a page number 224 for each media segment 202 of each media selection. The page number 224 may be input over the telephone to identify the media segment 202 to the voice server.

The browser interface 200 may further provide a search bar 214 to provide for keyword searching of media selections, for example, by subject matter, title, author, etc. In some embodiments, the search results could be presented in a window within the browser interface 200, for example, temporarily replacing the reading list window 212. In other embodiments, search results could be presented in an entirely new browser window. Selection of a new media title as a result of a search may transfer the sender into a purchasing module in order to purchase a chosen media selection for recording and ultimate fulfillment. Once the purchase transaction is complete, the user may be returned to the browser interface 200 and the newly purchased media selection may appear in the reading list window 212.

The browser interface 200 may further be provided with a help window 216. The help window may be intuitive and provide on-screen, step-by-step instructions to the sender depending upon what step in the annotation and recording process the sender is at. Alternately, or in addition, the help window 216 may be searchable by topic index or keyword to allow a sender to locate help for a specific question or problem the sender is experiencing. Further, the help window 216 may provide access to a “digital assistant” through a series of pre-recorded tutorial and trouble-shooting videos which are displayed using streaming media, or other similar technologies, within the help window 216 of browser window 200, or in an entirely new browser window. Step-by-step instructions may be provided to the sender via a telephone input system accessed by dialing a telephone number 220 provided for recording. The telephone number 220 may give the sender access to an automated help service and/or a live customer representative. Alternatively, the sender may be provided with a separate telephone number for help. The automated help service may be interactive via touchtone or voice recognition controls.

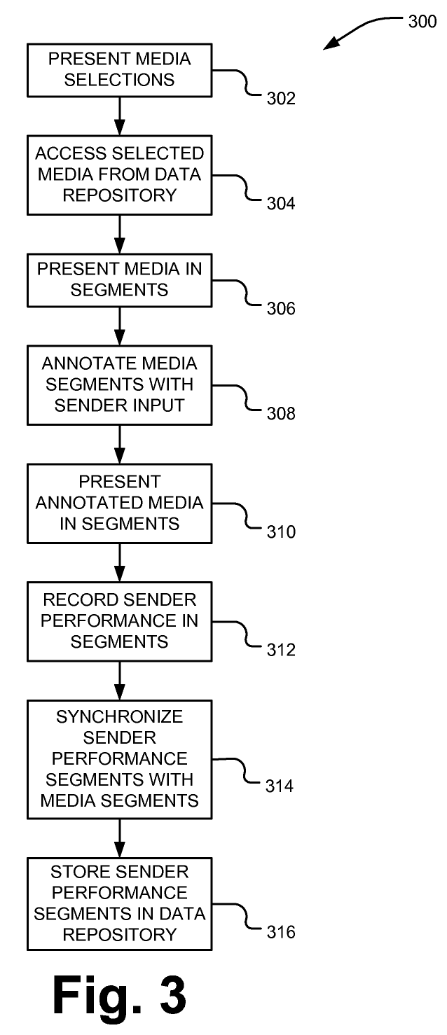

An exemplary process 300 for synchronizing a display of media and recording audio of the sender across the network is depicted in FIG. 3. Initially, in a presentation operation 302, media selections, for example, a selection of books, are presented to the sender in a browser interface. It should be understood that other forms of media in addition to books, for example, music (e.g., songs for karaoke singing), video (e.g., for commentary or narration), and other similar forms of media, may be presented to the sender for selection and recording.

Upon receipt of a media selection from a sender, the selected media file may be accessed from a data store in accessing operation 304. The media file may be processed by the MDRS application for presentation of the media selection in segments, such as, for example, pages of a book, or “chapters” of a video, as indicated in presentation operation 306. As described above, the media selection segments may be presented to a sender, for example, through the use of a browser interface. The browser interface may provide additional controls to the sender for recording of the text with annotation and commentary. The browser interface may also provide the sender with a telephone number where the sender may access the voice server for recording of the text with annotation and commentary. Upon receipt of annotation comments from the sender, the annotation information is associated with the corresponding media segment in the media file in annotation operation 308.

The recording phase of the process 300 begins by presenting the annotated media segments to the user in presentation operation 310. The annotated media segments may be presented serially. However, the process 300 may provide functionality to the sender to allow for self directed recording. The sender's performance of the media selection is then recorded on a segment by segment basis as indicated in recording operation 312. The recorded segments may then be synchronized with the respective media segments in synchronizing operation 314. Each of the recorded segments may be tagged or marked with identification information to track the association of the recorded segments with a particular sender, with each other, and with the media selection and the media segments. These associations may take place through the use of database tables, file headers for each recorded segment, or other well known data indexing or identification methodologies. Each of the sender's recorded performance segments may then be stored in a database repository in storing operation 316.

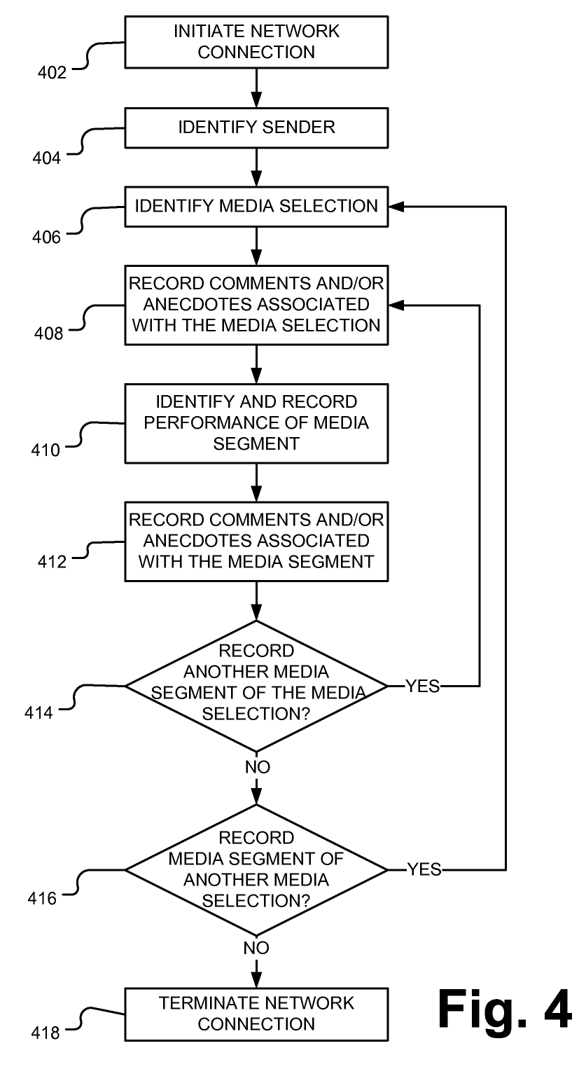

An exemplary process 400 for recording audio of the sender over a telephone is depicted in FIG. 4. The process begins when a network connection is initiated between the sender and the voice server in an initiation operation 402. This operation may be accomplished when the sender calls a specific telephone number associated with the voice server and the voice server answers the call, initiating the connection.

After the connection between the sender and the voice server is established, the sender may be audibly presented with menu selections. The sender may be instructed that the voice server utilizes an IVR system, a “touch-tone” DTMF system, or some other form of telephone input system to identify inputs from the sender. One exemplary menu option is to enter or obtain a sender identification in a sender identification operation 404. The sender may be in possession of a unique identification assigned by the media server and accessible to the sender via the web interface. In that case, the sender may be instructed to input the unique sender identification and the voice server will recognize the sender's identification number though the telephone input system. Alternatively, the sender may not be in possession of a sender identification. In that case, the sender may indicate the lack of a sender identification and the network server will recognize the sender's selection through the telephone input system, assign a sender identification to the sender, and audibly provide the sender identification to the sender. In yet another embodiment, the sender's name may operate as a sender identification.

Once the voice server has identified the sender, the telephone input system menu may audibly instruct the sender to identify a media selection in a media selection operation 406. The media selection may be assigned and marked with a unique identification number by the media server and accessible to the sender via the web interface. The sender may enter the media selection number and the voice server may recognize the sender's selection through the telephone input system. Alternatively, the sender may not be in possession of a unique media selection number because one was not provided by the media server or the sender cannot access the media server. In this case, the sender may use alternative identification to identify the media selection, for example, the title, author, subject, and/or ISBN number of the media selection. The alternative identification may be entered by the sender and recognized by the voice server through the telephone input system.

Once the voice server has identified the sender and the media selection, the telephone input system menu may give the sender an option to record comments and/or anecdotes generally associated with the media selection in a media selection recording operation 408. The voice server may instruct the sender to first make a touch-tone selection or say a unique audible command to begin recording, record any media selection comments and/or anecdotes, and then make another touch-tone selection or say a unique audible command to end recording. Alternatively, the telephone input system may be configured such that recording may begin and/or end after a certain period of silence from the sender. Further, the telephone input system may give the sender the option of reviewing the comments and/or anecdotes and re-recording if the sender is dissatisfied with the previous recording.

The telephone input system menu may next audibly instruct the sender to identify and record a media segment of the media selection in a media segment performance operation 410. Media segments may be directly associated with page numbers in a media selection or other identification system that identifies disparate sections of a media selection. The sender may enter the page number or other segment identification and the voice server may recognize the sender's selection through the telephone input system. The sender may then be instructed by the telephone input system to record a performance of the media segment in a manner similar to recording comments and/or anecdotes as described above.

Further, the telephone input system menu may give the sender the option to record comments and/or anecdotes specifically associated with the media segment of the media selection in a media segment annotation operation 412. The sender may then be instructed by the telephone input system to record a performance of the comments and/or anecdotes specifically associated with the media segment in a manner similar to recording comments and/or anecdotes generally associated with the media selection as described above. Alternatively, the sender may record such commentary and anecdotes as part of the performance of the media segment in operation 410.

Next, the telephone input system menu may give the sender the option to record another media segment of the media selection in the next media segment operation 414. If the user chooses to record another media segment, the user repeats the media segment performance operation 410 and the media segment annotation operation 412 as described above in association with the new media segment.

The telephone input system menu may also give the sender the option to record media segments of another media selection in the next media selection operation 416. If the user chooses to record another media selection, the user repeats the media selection operation 406, the media selection recording operation 408, the media segment performance operation 410, the media segment annotation operation 412, and the next media segment operation 414 as described above in association with the new media selection.

When the sender is finished recording media segments associated with one or more media selections, the sender may elect to terminate the network connection in a network termination operation 418. The sender may indicate to the voice server to terminate the connection by making a selection using the telephone input system or by simply hanging up the telephone. When the voice server recognizes that the sender desires to terminate the network connection, the voice server terminates the connection and proceeds in conjunction with the media server to the synchronizing operation 314 and storing operation 316 as described above in association with FIG. 3. While a recording operation has just been presented using voice and touchtone command, recall that the system is also operational to support the telephone network recording using the visual controls on the web browser interface as described with respect to FIG. 2 at any time as an alternate to the touchtone or voice controls.

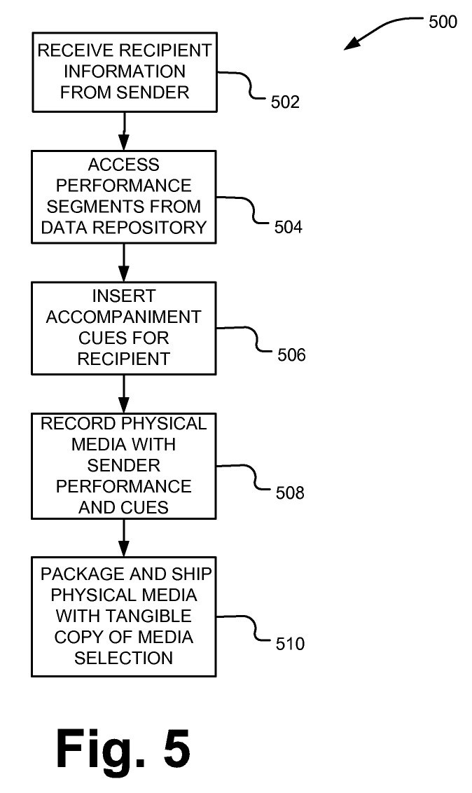

One exemplary implementation of a fulfillment process 500 for providing the recipient with copies of the sender's media selection and recorded performance are presented in FIG. 5. In order to initiate the fulfillment process 500, identification information for the recipient must be known. Such identification information may include the recipient's name, a mailing address, an e-mail address, a telephone number, or other contact information. This contact information may be received from the sender in receiving operation 502.

Once a particular recipient is identified and a media selection and recorded performance are associated with the recipient, the recorded performance segments may be accessed from the data repository in accessing operation 504. If not previously completed during the process of recording the sender's performance, accompaniment cues may be inserted between the performance segments for the benefit of the recipient as indicated in inserting operation 506. Exemplary accompaniment cues may include extended pause periods between recorded segments, for example, to allow a recipient to view pictures accompanying text on the page of a book. Other accompaniment cues may instruct the recipient to turn the page when viewing a book. Alternately, the sender may be given the option of recording one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

Once any accompaniment cues have been inserted into the performance segments, the entire performance of the sender may be recorded to a physical media for example by burning a CD or DVD with the performance data as indicated in recording operation 508, or copying the performance data to a flash memory storage media. Once a sender's performance has been recorded onto physical media, a fulfillment center may be notified to package the recorded media in conjunction with a tangible copy of the media selection of the sender, e.g., the accompanying book, and ship the package to the recipient using the contact information collected from the sender as indicated in notifying operation 510. In some implementations, the physical media and the tangible copy may be the same physical object, for example, a DVD or video tape with recorded performance accompanying the video as part of the audio track. In another implementation, the physical media may be incorporated into the tangible object, for example, a flash memory chip storing the recorded performance may be imbedded in a book with playback control buttons.

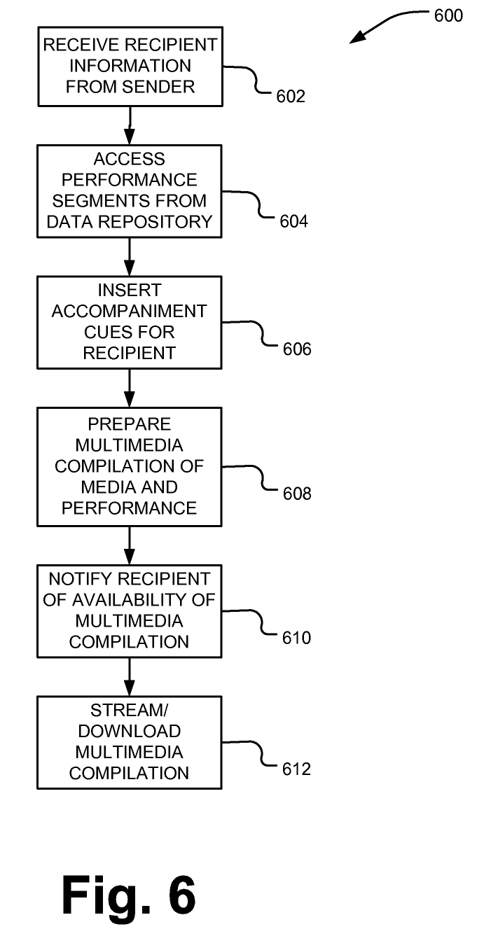

An alternate implementation of a fulfillment process 600 is depicted in FIG. 6. In order to initiate the fulfillment process 600, identification information for the recipient must be known. Such identification information may include the recipient's name, a mailing address, an e-mail address, a telephone number, or other contact information. This contact information is received from the sender in receiving operation 602.

Once a particular recipient is identified and a media selection and recorded performance are associated with the recipient, the recorded performance segments may be accessed from the data repository in accessing operation 604. If not previously completed during the process of recording the sender's performance, accompaniment cues may be inserted between the performance segments for the benefit of the recipient as indicated in inserting operation 606. Exemplary accompaniment cues may include extended pause periods between recorded segments, for example, to allow a recipient to view pictures accompanying text on the page of a book. Other accompaniment cues may instruct the recipient to turn the page when viewing a book. Alternately, the sender may be given the option of recording one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

Once any accompaniment cues have been inserted into the performance segments, a multimedia compilation of the media selection and the sender's recorded performance may be prepared in preparation of operation 608. For example, in the case of a book, bitmap images of each page of the book, including text and illustrations, may be time synchronized for display with the sender's recorded performance for that particular page of the book. Alternatively, if the selected media is a song, the sender's performance of the song may be synchronized and overlaid with the instrumental tracks of the song to create a karaoke performance. Further if the selected media is a video, the sender's commentary or narration may be synchronized with the video to create a complete multimedia compilation.

Once a multimedia compilation is complete, the recipient may be notified of the availability of the multimedia compilation as indicated in notification operation 610. This notification may be in the form of an electronic mail message sent, and/or a wireless phone “text message,” and/or an “instant” chat message, a voice mail message and/or a postal service message, to an address of the recipient that is provided by the sender. Upon receipt of the notification message, a recipient may access the multimedia compilation, e.g., by selecting a hyperlink provided in the notification message or by using a browser program to navigate to a website that can provide the recipient access to the multimedia compilation. Alternatively, a recipient may access the audio component of the multimedia compilation via their telephone by dialing into the voice server.

Once the recipient locates the multimedia compilation, it may be presented to the user in any of several forms. For example, the user may download a file containing the multimedia compilation for playback on the recipient's computing device using standard media presentation software. Alternatively, the multimedia compilation may be presented to the user through the user's browser interface in the form of a streaming multimedia presentation. In a further implementation, fulfillment of the media selection may be performed by sending the recipient a physical copy of the media selection, e.g., a book, while the accompanying audio performance of the sender may be provided through a download of an audio file, e.g., an MP3 file, to the recipient's computing device or playback through a telephone. Playback of the audio file may be performed by recipient's computing device using standard audio player applications. Alternatively, the audio file may be copied from the recipient's computing device to an alternative playback device, for example, an MP3 player, or burned to a physical medium, e.g., a CD, for playback by the recipient using other devices then the recipient's computing device connected to the network.

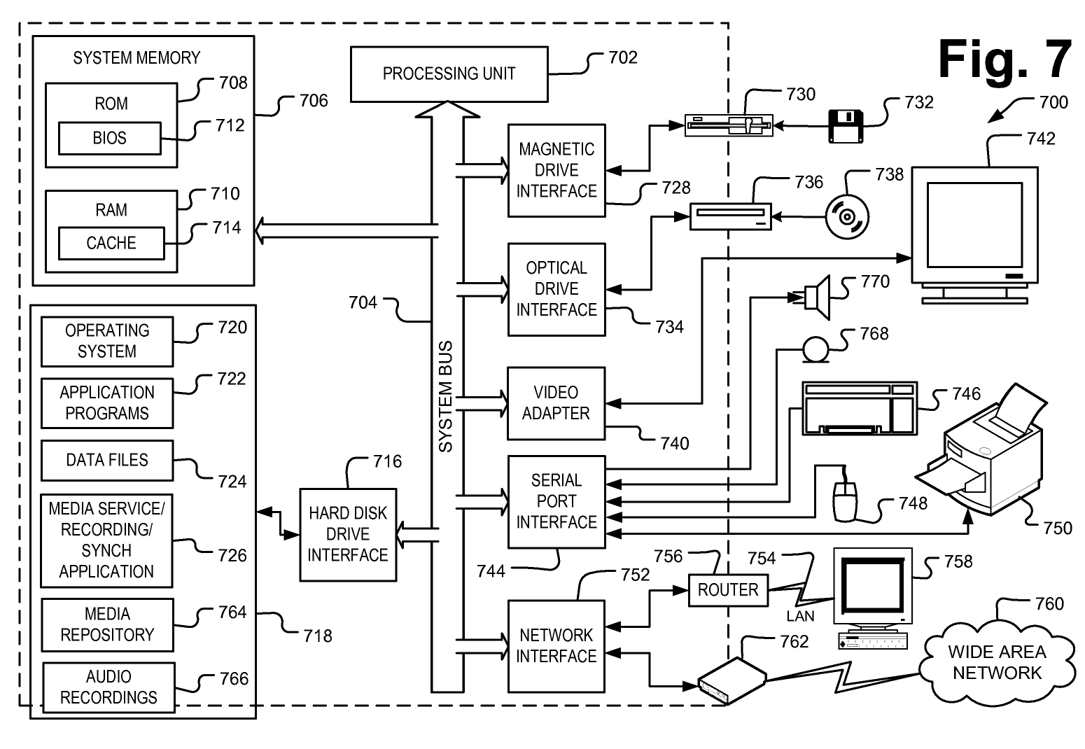

An exemplary computer system 700 for implementing the file origin determination processes above is depicted in FIG. 7. The computer system 700 of a sender or a recipient may be a personal computer (PC), a workstation, a notebook or portable computer, a tablet PC, a handheld media player (e.g., an MP3 player), a smart phone device, a video gaming device, or a set top box, with internal processing and memory components as well as interface components for connection with external input, output, storage, network, and other types of peripheral devices. Internal components of the computer system in FIG. 7 are shown within the dashed line and external components are shown outside of the dashed line. Components that may be internal or external are shown straddling the dashed line. Alternatively to a PC, the computer system 700, for example, for running the MDRS or VTRS applications, may be in the form of any of a server, a mainframe computer, a distributed computer, an Internet appliance, or other computer devices, or combinations thereof.

In any embodiment or component of the system described herein, the computer system 700 includes a processor 702 and a system memory 706 connected by a system bus 704 that also operatively couples various system components. There may be one or more processors 702, e.g., a single central processing unit (CPU), or a plurality of processing units, commonly referred to as a parallel processing environment (for example, a dual-core, quad-core, or other multi-core processing device). The system bus 704 may be any of several types of bus structures including a memory bus or memory controller, a peripheral bus, a switched-fabric, point-to-point connection, and a local bus using any of a variety of bus architectures. The system memory 706 includes read only memory (ROM) 708 and random access memory (RAM) 710. A basic input/output system (BIOS) 712, containing the basic routines that help to transfer information between elements within the computer system 700, such as during start-up, is stored in ROM 708. A cache 714 may be set aside in RAM 710 to provide a high speed memory store for frequently accessed data.

A hard disk drive interface 716 may be connected with the system bus 704 to provide read and write access to a data storage device, e.g., a hard disk drive 718, for nonvolatile storage of applications, files, and data. A number of program modules and other data may be stored on the hard disk 718, including an operating system 720, one or more application programs 722, and data files 724. In an exemplary implementation, the hard disk drive 718 may store the media service, recording, and synchronization application 726, the media data repository 764 for storage of media selections for presentation to a sender, and the audio recording data repository 766 for storing audio performances recorded by a sender according to the exemplary processes described herein above. Note that the hard disk drive 718 may be either an internal component or an external component of the computer system 700 as indicated by the hard disk drive 718 straddling the dashed line in FIG. 7. In some configurations, there may be both an internal and an external hard disk drive 718.

The computer system 700 may further include a magnetic disk drive 730 for reading from or writing to a removable magnetic disk 732, tape, or other magnetic media. The magnetic disk drive 730 may be connected with the system bus 604 via a magnetic drive interface 728 to provide read and write access to the magnetic disk drive 730 initiated by other components or applications within the computer system 700. The magnetic disk drive 730 and the associated computer-readable media may be used to provide nonvolatile storage of computer-readable instructions, data structures, program modules, and other data for the computer system 700.

The computer system 700 may additionally include an optical disk drive 736 for reading from or writing to a removable optical disk 738 such as a CD ROM or other optical media. The optical disk drive 736 may be connected with the system bus 704 via an optical drive interface 734 to provide read and write access to the optical disk drive 736 initiated by other components or applications within the computer system 700. The optical disk drive 730 and the associated computer-readable optical media may be used to provide nonvolatile storage of computer-readable instructions, data structures, program modules, and other data for the computer system 700.

A display device 742, e.g., a monitor, a television, or a projector, or other type of presentation device may also be connected to the system bus 704 via an interface, such as a video adapter 740 or video card. Similarly, audio devices, for example, external speakers or a microphone (not shown), may be connected to the system bus 704 through an audio card or other audio interface (not shown).

In addition to the monitor 742, the computer system 700 may include other peripheral input and output devices, which are often connected to the processor 702 and memory 706 through the serial port interface 744 that is coupled to the system bus 706. Input and output devices may also or alternately be connected with the system bus 704 by other interfaces, for example, a universal serial bus (USB), an IEEE 1394 interface (“Firewire”), a parallel port, or a game port. A user may enter commands and information into the computer system 700 through various input devices including, for example, a keyboard 746 and pointing device 748, for example, a mouse. Other input devices (not shown) may include, for example, a joystick, a game pad, a tablet, a touch screen device, a satellite dish, a scanner, a facsimile machine, a telephone, a digital camera, and a digital video camera. In implementations described herein, the computer system 700 of the sender may include a microphone 768 to capture the sender's performance. Output devices may include a printer 750 and one or more loudspeakers 770 for presenting the audio performance of the sender. Other output devices (not shown) may include, for example, a plotter, a photocopier, a photo printer, a facsimile machine, a telephone, and a press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 700 via the serial port interface 744 (e.g., USB) or similar port interface.

The computer system 700 may operate in a networked environment using logical connections through a network interface 752 coupled with the system bus 704 to communicate with one or more remote devices. The logical connections depicted in FIG. 7 include a local-area network (LAN) 754 and a wide-area network (WAN) 760. Such networking environments are commonplace in home networks, office networks, enterprise-wide computer networks, and intranets. These logical connections may be achieved by a communication device coupled to or integral with the computer system 700. As depicted in FIG. 7, the LAN 754 may use a router 756 or hub, either wired or wireless, internal or external, to connect with remote devices, e.g., a remote computer 758, similarly connected on the LAN 754. The remote computer 758 may be another personal computer, a server, a client, a peer device, or other common network node, and typically includes many or all of the elements described above relative to the computer system 700.

To connect with a WAN 760, the computer system 700 typically includes a modem 762 for establishing communications over the WAN 760. Typically the WAN 760 may be the Internet. However, in some instances the WAN 760 may be a large private network spread among multiple locations, or a virtual private network (VPN). The modem 762 may be a telephone modem, a high speed modem (e.g., a digital subscriber line (DSL) modem), a cable modem, or similar type of communications device. The modem 762, which may be internal or external, is connected to the system bus 718 via the network interface 752. In alternate embodiments the modem 762 may be connected via the serial port interface 744. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products. In one implementation, a computer program product is provided as a computer-readable medium storing an encoded computer program executable by a computer system. Another implementation of a computer program product may be provided in a computer data signal embodied in a carrier wave by a computing system and encoding the computer program. Other implementations are also described and recited herein.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for synchronizing a presentation of a media selection with a recording of an audio performance over a telephone network comprising
selecting a media file from a collection of media files stored in a first data repository;
presenting the selected media file to a sender device over a communication network;
receiving audio data corresponding to the selected media file from a sender telephone via a telephone network; and
synchronizing the audio data with the selected media file.

2. The method of claim 1 further comprising storing the synchronized audio data as one of a collection of recorded audio performances in a second data repository corresponding to one or more of the media files in the first data repository.

3. The method of claim 1 further comprising recording the received audio data which is input at the sender telephone and received via the telephone network.

4. The method of claim 3 further comprising
receiving recording instructions as DTMF tones, voice instructions, or both, from the sender telephone over the telephone network, and/or as user input from the sender device over the communication network; and
controlling the recording operation, at least in part, by the recording instructions.

5. The method of claim 3 further comprising providing audible input instructions to the sender telephone over the telephone network.

6. The method of claim 1 further comprising
receiving presentation instructions as DTMF tones, voice instructions, or both, from the sender telephone over the telephone network, and/or as user input from the sender device over the communication network; and
controlling the presenting operation, at least in part, by the presentation instructions.

7. The method of claim 1 further comprising providing an interface to the sender device including recording controls allowing a sender to control input and editing of the audio data received from the sender telephone.

8. The method of claim 1 further comprising
separating the selected media file into a group of media segments; and
presenting the media segments individually to the sender device.

9. The method of claim 8 further comprising recording the audio data which is input at the sender telephone and received via the telephone network in audio segments corresponding to respective media segments.

10. The method of claim 8 further comprising
providing a first interface feature to the sender device for presenting one of the media segments at a time on the sender device; and
providing a second interface feature to the sender device allowing a sender to input annotation information corresponding to a respective one of the media segments as cues during recording of a corresponding one of the audio segments.

11. The method of claim 10 further comprising
receiving instructions as DTMF tones, voice instructions, or both, from the sender telephone over the telephone network, and/or as user input from the sender device over the communication network; and
controlling the first interface feature and the second interface feature according to the instructions.

12. The method of claim 8 further comprising providing an interface to the sender device for presenting one of the media segments at a time on the sender device, the interface further including segment control features allowing a sender to select among the media segments for presentation.

13. The method of claim 12 further comprising
receiving instructions as DTMF tones, voice instructions, or both, from the sender telephone over the telephone network, and/or as user input from the sender device over the communication network; and
controlling the interface, including the segment control features, according to the instructions.

14. The method of claim 12 wherein the segment control features further provide for recording accompaniment cues for indicating a change between media segments.

15. The method of claim 1 further comprising
copying the synchronized audio data to a storage medium; and
providing the copy of the synchronized audio data to a recipient.

16. A computer-readable medium storing computer-readable instructions for controlling a server computer to synchronize a presentation of a media selection with a recording of an audio performance over a telephone network, wherein the instructions comprise operations to
select a media file from a collection of media files stored in a first data repository;
present the selected media file to a sender device over a communication network;
receive audio data corresponding to the selected media file from a sender telephone via a telephone network; and
synchronize the audio data with the selected media file.

17. The computer readable medium of claim 16, wherein the instructions further comprise operations to store the synchronized audio data as one of a collection of recorded audio performances in a second data repository corresponding to one or more of the media files in the first data repository.

18. The computer readable medium of claim 16, wherein the instructions further comprise operations to record the received audio data which is input at the sender telephone and received via the telephone network.

19. The computer readable medium of claim 18, wherein the instructions further comprise operations to
receive recording instructions as DTMF tones, voice instructions, or both, from the sender telephone over the telephone network, and/or as user input from the sender device over the communication network; and
control the recording operation, at least in part, by the recording instructions.

20. The computer readable medium of claim 18, wherein the instructions further comprise operations to provide audible input instructions to the sender telephone over the telephone network.

21. The computer readable medium of claim 16, wherein the instructions further comprise operations to
receive presentation instructions as DTMF tones, voice instructions, or both, from the sender telephone over the telephone network, and/or as user input from the sender device over the communication network; and
control the presenting operation, at least in part, by the presentation instructions.

22. The computer readable medium of claim 16, wherein the instructions further comprise operations to provide an interface to the sender device including recording controls allowing a sender to control input and editing of the audio data received from the sender telephone.

23. The computer readable medium of claim 16, wherein the instructions further comprise operations to
separate the selected media file into a group of media segments; and
present the media segments individually to the sender device.

24. The computer readable medium of claim 23, wherein the instructions further comprise operations to record the audio data which is input at the sender telephone and received via the telephone network in audio segments corresponding to respective media segments.

25. The computer readable medium of claim 23, wherein the instructions further comprise operations to
provide a first interface feature to the sender device for presenting one of the media segments at a time on the sender device; and
provide a second interface feature to the sender device allowing a sender to input annotation information corresponding to a respective one of the media segments as cues during recording of a corresponding one of the audio segments.

26. The computer readable medium of claim 25, wherein the instructions further comprise operations to
receive instructions as DTMF tones, voice instructions, or both, from the sender telephone over the telephone network, and/or as user input from the sender device over the communication network; and
control the first interface feature and the second interface feature according to the instructions.

27. The computer readable medium of claim 23, wherein the instructions further comprise operations to provide an interface to the sender device for presenting one of the media segments at a time on the sender device, the interface further including segment control features allowing a sender to select among the media segments for presentation.

28. The computer readable medium of claim 27, wherein the instructions further comprise operations to
receive instructions as DTMF tones, voice instructions, or both, from the sender telephone over the telephone network, and/or as user input from the sender device over the communication network; and
control the interface, including the segment control features, according to the instructions.

29. The computer readable medium of claim 27, wherein the operations to control the segment control features further comprise providing for recording accompaniment cues for indicating a change between media segments.

30. The computer readable medium of claim 16, wherein the instructions further comprise operations to
copy the synchronized audio data to a storage medium; and
provide the copy of the synchronized audio data to a recipient.

31. A system for synchronizing a presentation of a media selection with a recording of an audio performance over a telephone network comprising
a first data repository for storing a collection of media files;
a communication network link;
a media server configured to access a media file from the first data repository and present the accessed media file to a sender device via the communication network link; and
a voice server configured to receive audio data corresponding to the selected media file from a sender telephone via a telephone network; wherein
the media server and the voice server coordinate operations to synchronize the audio data with the accessed media file.

32. The system of claim 31, wherein the voice server is further configured to record the received audio data which is input at the sender telephone and received via the telephone network.

33. The system of claim 32 further comprising
a second data repository; and wherein
the voice server is further configured to store the synchronized audio data as one of a collection of recorded audio performances in the second data repository corresponding to one or more of the media files in the first data repository.

34. The system of claim 32, wherein
the voice server is further configured to receive recording instructions as DTMF tones generated by the sender telephone, voice instructions input in the sender telephone, or both, over the telephone network, and/or
the media server is further configured to receive recording instructions as user input from the sender device over the communication network; and
the voice server is further configured to control the recording operation, at least in part, by the recording instructions.

35. The system of claim 34, wherein the voice server is further configured to provide audible input instructions to the sender telephone over the telephone network.

36. The system of claim 31, wherein
the voice server is further configured to receive presentation instructions from the sender telephone as DTMF tones, voice instructions, or both, over the telephone network, and/or
the media server is further configured to receive presentation instructions as user input from the sender device over the communication network; and
the media server is further configured to control the presenting operation, at least in part, by the presentation instructions.

37. The system of claim 31, wherein the media server is further configured to provide an interface to the sender device including recording controls allowing a sender to control input and editing of the audio data received from the sender telephone.

38. The system of claim 31, wherein the media server is further configured to
separate the selected media file into a group of media segments; and
present the media segments individually to the sender device.

39. The system of claim 38, wherein the voice server is further configured to record the audio data which is input at the sender telephone and received via the telephone network in audio segments corresponding to respective media segments.

40. The system of claim 38, wherein the media server is further configured to
provide a first interface feature to the sender device for presenting one of the media segments at a time on the sender device; and
provide a second interface feature to the sender device allowing a sender to input annotation information corresponding to a respective one of the media segments as cues during recording of a corresponding one of the audio segments.

41. The system of claim 40, wherein
the voice server is further configured to receive instructions from the sender telephone as DTMF tones, voice instructions, or both, over the telephone network, and/or
the media server is further configured to receive instructions as user input from the sender device over the communication network; and
the media server is further configured to control the first interface feature and the second interface feature according to the instructions.

42. The system of claim 38, wherein the media server is further configured to provide an interface to the sender device for presenting one of the media segments at a time on the sender device, the interface further including segment control features allowing a sender to select among the media segments for presentation.

43. The system of claim 42, wherein
the voice server is further configured to receive instructions from the sender telephone as DTMF tones, voice instructions, or both, over the telephone network, and/or
the media server is further configured to receive instructions as user input from the sender device over the communication network; and
the media server is further configured to control the interface, including the segment control features, according to the instructions.

44. The system of claim 42, wherein the segment control features further provide for recording accompaniment cues for indicating a change between media segments.

45. The system of claim 31, wherein the media server is further configured to
copy the synchronized audio data to a storage medium; and
provide the copy of the synchronized audio data to a recipient.
